(19) United States
(12) Patent Application Publication
(10) Pub. No.: US 2016/0121324 A1
(43) Pub. Date: May 5, 2016

(54) LASER-IMPRINTABLE SAMPLE TUBE

(71) Applicants: LVL TECHNOLOGIES GMBH & CO. KG, Crailsheim (DE); MARANDJO SOLUTIONS & SERVICES LDA & COMANDITA, Funchal Madeira (PT)

(72) Inventor: Adam Matthias Koch, Gyärkäny (HU)

(21) Appl. No.: 14/896,130

(22) PCT Filed: Jun. 5, 2014
(86) PCT No.: PCT/EP2014/061712

§ 371 Date: Dec. 4, 2015

(30) Foreign Application Priority Data
Jun. 6, 2013 (DE) 10 2013 009 468.2

(51) Int. Cl. B01L 3/00

(52) U.S. Cl. CPC B01L 3/5082; B01L 3/50825; B01L 2300/0832; B01L 2300/0858; B01L 2300/02; B01L 2300/12; B01L 2300/042; B01L 2300/046; B01L 2200/025; B01L 2200/12

(57) ABSTRACT

The invention relates to a sample tube with a writable area, in particular a sample tube in which the color of the writable area changes by means of irradiation, and to a process for the production of such a sample tube.

### FIELD OF THE INVENTION

The invention relates to a sample tube with a writable area, in particular a sample tube in which the color of the writable area changes by means of irradiation, and to a process for the production of such a sample tube.

### STATE OF THE ART

Conventional sample tubes are used for the storage and the transport of liquid samples which are used, for example, in chemical, biochemical or biological research laboratories or also in clinics. Sample tubes can be formed in different sizes depending on the quantity of the sample it is necessary to store.

The sample tubes usually consist of different plastics which are produced in an injection-molding process with the same or different materials. For this, a sample tube is usually injection-molded from a transparent material and cured by cooling. In a second step, a writable area is then secured to the sample tube at the point provided for this, for example by gluing a writable plate to the tube, welding with a laser process or carrying out a second injection-molding step at the point provided for this. So-called multi-component processes are often mentioned. This requires correspondingly several different process steps and is therefore not optimal in particular from a production point of view. The writable area is usually a plastic which changes its optical properties by means of irradiation, i.e. the writable area is irradiated and the irradiated area thereupon changes its color, with the result that, depending on the irradiated material, for example a barcode or a so-called 2D barcode (Datamatrix code) can be seen. This serves to differentiate the individual sample tubes, with the result that a mix-up can be ruled out and, in addition, machine readability can be provided.

CH 699 407 A1 discloses a sample tube with a top opening surrounded by side walls. The side walls merge into a base, which comprises an essentially flat underside, which faces away from the top opening. The sample tube comprises an identification area which is located on the underside of the sample tube and which consists of a non-transparent material with a first color and a transparent cover layer. The transparent cover layer contains a laser-sensitive filler which becomes non-transparent by means of irradiation with a laser and thus forms a contrast on the base layer of the non-transparent material on which that which has been written with the laser can then be seen. Here too, the tube must be produced first and then the non-transparent material must be applied to the hardened tube in the form of a plastic plaque. Subsequently, the laser-sensitive material is then secured over the non-transparent material. The sample tube which is shown in WO 2010/023 102 A1 also functions in a similar way.

### DESCRIPTION OF THE INVENTION

The object of the invention is now to produce a sample tube which is simple to write on with little effort.

The object is achieved by a sample tube with a writable area, wherein the sample tube has a main body made of a first component and a writable area made of a second component, wherein the sample tube is formed in one piece from the first and second components. In this case, in one piece means that the main body and the writable area are produced in one process step, such as for example an injection-molding process, in particular with a wet-on-wet technique. By this means, a sample tube is obtained which is simple to write on and is convenient to produce. Wet-on-wet technique is not related to the conventional 2-component technique and is to be distinguished from the latter.

The object of the invention is also achieved by a sample tube with a writable area, which comprises a main body made of at least one polymer, wherein in one area the polymer has an additive which gives the polymer a writable property and thus forms the writable area. In this way, the sample tube can be produced quite simply, also from one component, and an additive can be added in the liquid or solid state of the polymer. Preferably, the dye and the additive are mixed in in the solid state and homogenized in the cylinder of the machine during the melting process.

The writable area of the sample tube is preferably formed at the base of the tube. This not only simplifies the production of the sample tube because the feed channels of the tool can be clearly separated, but also ensures that the contact area (i.e. the area at which the two components combine in the liquid state) can be produced uniformly for all sample tubes without large tolerance differences. The two materials flow into each other and combine. By means of this “free” flow, runs of the transparent and the colored components form in the transition area.

The second component preferably comprises a polymer with an additive which gives the polymer a writable property. For example, the additive can comprise colored pigments which change their color by means of irradiation or the additive itself can change its color by means of the thermal energy exerted in the laser irradiation. Preferred additives or pigments or also dyes are so-called thermochromic substances which change color by means of the influence of thermal energy, e.g. as in the case of a laser, by means of conformational change. In particular, a change from black to white or white to black is preferred as the contrast is greatest here.

Furthermore, the second component can comprise the same polymer as the first component, with the result that the sample tube basically consists of the same substance. This is not only advantageous for the production but also guarantees the same material properties for the storage and handling of the tubes, with the result that damage by means of different coefficients of thermal expansion can be avoided (if e.g. the sample tubes have to be deep-frozen).

The second component preferably changes its color by means of irradiation, in particular laser irradiation, with the result that the writing on the writable area can thereby be recognized. It is particularly preferred that the second component is already colored in the starting state as a better contrast thereby results in the case of two colors (irradiated (e.g. red) and not irradiated (e.g. black)).

A further subject of the invention is a sample tube as described above further comprising a closure.

The closure can be a screw cap with an internal thread or external thread or a stopper.

The stopper is preferably a polymer stopper which has a slot or crossed slot. A sample can thereby be removed from the sample tube with a cannula without damaging the structure of the stopper. In contrast to the conventional piercing of the stopper with a cannula, the stopper according to the invention ensures as airtight as possible a closure of the sample tube after the removal of the sample. Hardly any ambient air is thus able to enter the sample tube.

It is further preferred if the screw closure is a 2-component polymer in which is comprised a seal as integral constituent. This means that a seal can be integrated into the screw closure in a process step by means of a conventional 2-component procedure. By this means, work steps and costs can be saved. Moreover, it is possible for the seal not to be lost on opening the tube. The screw closure is preferably also made of PP.

A process for producing a sample tube with a writable area in which a first and second component are injected into a cavity of an injection-molding tool comprises the steps injection of a first component to form a sample tube main body and the injection of a second component to form the writable area, wherein the injection of the second component takes place in such a way that the first and the second component together form a one-piece sample tube and in particular form a contact area. This process represents a wet-on-wet injection-molding process, wherein a polymer with an additive (dye) is preferably used as second component. In particular, the polymer of the first component is the same as the polymer of the second component. The injection of the two components preferably takes place at least partially simultaneously.

### BRIEF DESCRIPTION OF THE DRAWINGS

FIG. 1 shows a sample tube according to the present invention.

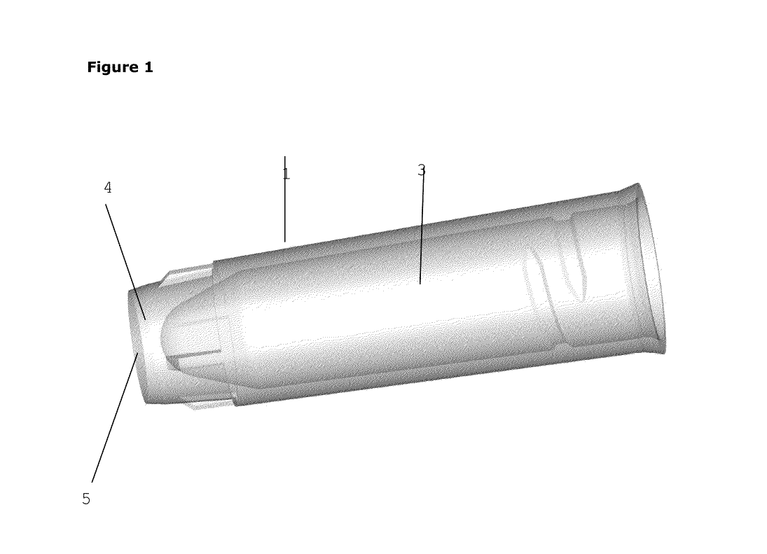

### DESCRIPTION OF THE PREFERRED EMBODIMENTS

In the following, the terms “axial”, “radial” and “circumferential” are used. “Axial” indicates a direction along a longitudinal axis of the sample tube, “radial” a direction perpendicular to the longitudinal axis and “circumferential” a direction along the circumference of the sample tube in the plane of the radial directions. Furthermore, an “upper end” is an end which can be closed with the cap and a “lower end” is the closed end of the sample tube.

The sample tube 1 consists essentially of side walls 3 and a base 4 which form a main body 3 and a writable area 5. The sample tube 1 further comprises a cap (not shown), which can be screwed on, secured with a clip closure or attached to the tube in another common way in the usual manner.

The main body 3 of the tube is preferably made from a transparent plastic, such as a polymer. Polypropylene in particular lends itself as basic component for this; however, other polymers and plastics which are suitable for this purpose, which are known to a person skilled in the art, can likewise be used.

At one point, the tube 1 has a writable or markable area 5 which can be written on/marked on the finished sample tube 1 by means of a corresponding device. Thus barcodes can be formed on this area 5 for example. This preferably occurs by means of irradiation of the writable area, wherein the material of which the writable area consists reacts to the irradiation in such a way that it changes color in the irradiated area. A laser irradiation in particular is very suitable for this. However, the writable area can also be written on by means of excessive generation of heat, for example by means of radiated heat or also by means of a very hot stamp.

In the preferred embodiment, the writable area 5 is formed at the base of the sample tube as this has advantages for the manufacture because the injection channels can advantageously be arranged at a distance from each other. A polymer, in particular the same polymer as for the main body, also lends itself as material, wherein the polymer further has an additive, in the present case for example a dye or paint particle, which change their color under irradiation or generation of heat. In particular, the additive with the trade name Iriotec® 8835 from Merck, Darmstadt can be used. Further additives which can be used within the meaning of the invention are MAXITHEN® HP 9B5757LS black and MAXITHEN® HP HP1279LS white from Gabriel Chemie. However, the writable area 5 can also be arranged at any other point of the tube. It is only necessary then to adapt the injection channels of the injection-molding tool accordingly.

In principle, the same substances come into consideration as material of the second component for the writable area 5 as for the main body. The second component can, of course, also be transparent and change its color under irradiation; however, the second component is preferably already colored before the irradiation. By this means, when the second component changes its color under irradiation, a better contrast is achieved than with a transparent second component.

A sample tube, as described above, is produced in a tool provided therefor. The tool comprises a cavity (the hollow space into which the first and second components are injected) which is bounded on the outside by the walls of the cavity and on the inside by a core lying in the cavity. Put simply, the shape of the sample tube is formed as a hollow space in a molding tool. One or more sprues, in the present case in particular two channels, lead into this hollow space. The first channel is established in an upper area of the cavity, the second channel in the area of the lower end of the cavity. As stated, it is possible, however, to develop it according to requirements, i.e., if the writable area is to be designed not at the base but on the side wall, the sprue for the second component can also be arranged centrally in the cavity. For example, one or two injection channels for the first component can then also be provided above and/or below it.

According to a further embodiment of the invention, the molding tool has a runner from which the injection channel extends into the cavities in the form of a star. I.e., the runner is arranged centrally and for example four to twelve cavities for a sample tube, which are each connected to the runner via an injection channel, are formed in the shape of a star in a circle around it. By this means, several sample tubes can be produced at the same time, which increases the efficiency of the production. This is then true of course for the first and the second components or for their injection channels respectively. The tool can also be designed as a full hot runner system; then the runner is dispensed with. Moreover, a tool is not limited to 12 cavities but can have an indefinite number of cavities.

The tool itself is divided into several planes, i.e., there is an upper plate with the respective injection channels for the first component, and a lower plate with the injection channels for the second component. In addition, there can also be a middle plate, which then in each case has only the cavity and no sprues. In contrast, the core is formed in one piece (from one piece) and at the upper tool plate. In particular, a thread which can serve to close the tube with a cap is also then already molded on the core or on the outer wall of the cavity respectively. In the case of a tube which has an external thread, the thread is located in sliders or flanges of the tool. These are movable parts which remove the thread from the mold.

To produce the sample tube, the tool is now closed and the materials (transparent first component and the second component) of the article are injected in in parallel. In order that the bulk of the main body consists of the first component, either the injection of the second component can be started later, or the injection channel is formed with a correspondingly smaller volume, with the result that the bulk of the tube is produced from the first component.

The first and second components are provided in corresponding containers (e.g. cylinders of the injection-molding machine) which are connected to the respective runners or the injection channels. The materials are now injected in, either simultaneously or with a slight time lag, with the result that the two components, which are still liquid, mix. The meeting of the two materials is called the joint line and represents a mixed transition area in which the first and the second components mix and, after curing, are formed as a one-piece tube.

In a preferred shape, the joint line is formed in an area B such that the meeting of the materials occurs at a height of in particular 2 mm. This meeting is, however, different or can vary from injection to injection and from cavity to cavity. In the case of 2 mm for example by +/−1.5 mm. In another preferred embodiment, the writable area can also only be formed at the base 4, thus the joint line and the contact area lie under the side walls. The entire content of the sample tube thereby becomes visible, as long as the first component is transparent.

After the volumetric filling of the cavity, an injection channel is closed and the holding pressure in the cavity is conducted via the respective other component. For this (for the holding pressure), the colored component is preferably used so that it is ensured that the writable area is also sufficiently large. As this only relates to the holding pressure, however, which only relates to the shrinkage of the plastic which is located in the cavity after the injection, it is simultaneously also ensured that the writable area does not inadvertently become too large. After the holding pressure, the cast or injected sample tube is cooled and the tool is opened such that the plastic article (the sample tube) can be discharged. The discharge takes place via an ejection-side stripper plate, as a rule the discharge of the gates also takes place via the stripper plate which strips the sample tubes from the core. However, it can also be carried out with the aid of ejector pins which are preferably located in the injection channels. In brief, the process sequence can be described as follows: The tool closes, both materials are injected in, the plastic article is cooled and the tool opens. The plastic article and the gate of the transparent component are stripped off or discharged and fall down into the delivery chute of the machine. In the present case, the production of sample tubes was carried out in this way by POLAR-FORM.

For the cooling, the injection-molding tool has in particular cooling equipment (e.g. a water cooling system) in order to accelerate the production.

Such a sample tube can, of course, also consist of more than only two components, with the result that, depending on the requirement, different materials with different properties can be used. Of course, for this different injection channels must also then be provided. It is important, however, that the materials can be mixed such that at the end a one-piece sample tube is formed. In addition, other components can also be attached to the sample tube of course.

1. A sample tube with writable area which comprises a main body made of a first component and a writable area made of a second component, wherein side walls and base of the sample tube are formed in one piece from the first and second components.

2. The sample tube according to claim 1 in which the writable area is formed at the base of the sample tube.

3. The sample tube according to claim 1 in which the second component comprises a polymer with an additive which gives the polymer a writable property.

4. The sample tube according to claim 3 in which the first and the second components comprise the same polymer as basic component.

5. The sample tube according to claim 1 in which the writable area can be written on by means of irradiation.

6. The sample tube according to claim 1 in which the second component is not transparent before irradiation.

7. The sample tube with writable area which comprises a main body made of at least one polymer, wherein in one area the polymer has an additive which gives the polymer a writable property and thus forms the writable area.

8. The sample tube according to claim 7, further comprising a closure.

9. The sample tube according to claim 8, wherein the closure is a screw cap with an internal thread or external thread or a stopper.

10. The sample tube according to claim 9, wherein the stopper is a polymer stopper which has a slot or crossed slot.

11. The sample tube according to claim 9, wherein the screw cap closure is a 2-component polymer in which is comprised a seal as integral constituent.

12. A process for producing a sample tube with writable area in which a first and a second component are injected into a cavity of an injection-molding tool comprising the steps:
injection of a first component to form a main body of the sample tube;
injection of a second component to form the writable area;
wherein the injection of the second component takes place in such a way that the first and second component together form the side walls and the base of the sample tube in one piece.
